(19) United States
(12) Patent Application Publication
(10) Pub. No.: US 2013/0317903 A1
(43) Pub. Date: Nov. 28, 2013

(54) INTEGRATED SYSTEM FOR DISPLAYING ITEMS AND FOR MEASURABLE PROMOTIONAL COMMUNICATION

(71) Applicant: Riccardo Majrani, Chambesy (CH)

(72) Inventor: Riccardo Majrani, Chambesy (CH)

(73) Assignee: POP CHANNEL S.R.L., PESCHIERA BORROMEO (MI) (IT)

(21) Appl. No.: 13/982,228

(22) PCT Filed: Jan. 27, 2012
(86) PCT No.: PCT/IB2012/050392

§ 371 Date: Jul. 26, 2013

(30) Foreign Application Priority Data
Jan. 28, 2011 (IT) MI2011A 000099

(51) Int. Cl. G06Q 30/02

(52) U.S. Cl. CPC G06Q 30/0246
USPC 705/14.45

(57) ABSTRACT

An integrated system for displaying items and for promotional communication is described comprising at least one stand module (10) for items, having in turn one or more support means (18) designed to contain and/or to support the products (36) to be displayed, and at least one screen (12) and/or one panel able to visualize a series of static or dynamic advertising messages. The system has at least one electronic device for acquiring dynamic images (14), able to detect a series of information relating to the people that are within a predefined distance from the stand module (10) for items, at least one device for automatically identifying items (38; 40), able to detect and identify how many and which products (36) are present on the stand module (10), as well as a central processing unit (16) operatively connected.

The present invention refers to an integrated system for displaying items, in particular products intended to be sold, and for promotional communication.

In the field of communication in general outlets (shops, shopping centres, etc.), both for promoting branded products and for promoting products and services of the distribution companies, it is known to use special promotional stands for products being sold. Such stands can be made from many different kinds of material. Indeed there are stands for products, which may or may not be dismountable, made from durable material, like for example metal and plastic, from semi durable material, like for example metal and undulated cardboard, or from non-durable material, like for example paper and undulated cardboard.

Irrespective of the type of material with which they have been made, such stands for products can be provided with supports for the promotional communication of both the static type, like for example panels on which advertising information has been printed, and of the dynamic type, like for example screens on which advertising messages are displayed.

Over the last fifteen years, the field of communication in shops for the public has had a very steady growth rate, due to the fact that promotional communication forms a strategic element for companies, which have identified the possibility of installing promotional communication means in such shops. Communication in shops indeed means, in preferential or highlighted display, meeting a large number of potential customers that go to numerous shops and that pay close attention to everything that is put on sale.

Based upon preeminent research (“POPAI—the global association for marketing at retail”) it is estimated that over two thirds of purchasing decisions are made in the moment dedicated to shopping itself, that is, inside shops. In other words, it has been highlighted that although customers plan the purchase of a product listed in their own shopping list, the choice of the brand and of the final product, in 67% of sample clients, will be carried out at the shop.

It is therefore clear that a greater visibility of the products, effective promotional communication and a suitable product range in shops make it possible to obtain enormous competitive advantages both for the manufacturers, and for the managers of the shops themselves.

One or more communication means, installed at the stands for products of a certain shop, which are capable of presenting a product in a visible form and of clearly and dynamically communicating all the relative information during purchases, translate into an active medium which, in addition to informing customers, can significantly increase sales. Consequently, if we project such a system for displaying products and for customer communication on a larger scale (national), focusing it on more significant sales areas, a mass communication effect is obtained for millions of customers which go to make their purchases every week.

One important drawback of current stands for products provided with elements that are useful for communication, be they of the static type, like printed panels, or made up of dynamic supports, like audio/video systems for promotional communication, however, is due to their lack of “measurability”. In other words, with the current stands for products provided with a static communication support, like printed panels, or audio/video support for promotional communication, it is not possible to directly evaluate, in an automatic and precise manner, the actual number of clients that are potentially interested in the product being displayed and in the relative advertising message.

In addition, the lack of “measurability” of the actual stands for products provided with elements that are useful for communication also translates into the impossibility of automatically determining the amount of sold goods. In other words, such stands for products do not make it possible to precisely verify, instantaneously or over a certain time period, how many and which products have been taken from the stand itself, especially in relation to the type of customers which are purchasing such products.

The purpose of the present invention is therefore that of making an integrated system for displaying items and/or products and for promotional communication that is capable of measuring, in a detailed manner, the number of contacts with the potential customers or, in other words, which is capable of measuring the number of customers potentially interested in the objects displayed.

Another purpose of the invention is that of making an integrated system for displaying items and/or products and for promotional communication that is capable of distinguishing the various types (whether male or female, age, etc.) of customers that are potentially interested in the objects being displayed and, consequently, of adapting, in a dynamic manner, the advertising messages to be transmitted. Indeed, after the recognition of a certain profile, the system is capable of directly proposing on one or more monitors, in an automatic and dynamic manner and in real time, the corresponding message studied for that certain target, with the aim, therefore, of having communication that is completely targeted at the potential interested customer.

A further purpose of the invention is that of making an integrated system for displaying items and/or products and for promotional communication that is capable of determining in an automatic and precise manner, in a certain moment or over a period of time, how many and which products have been taken from the stand itself and from which type of customer.

Yet another purpose of the invention is that of making an integrated system for displaying items and/or products and for promotional communication that is capable of operating in an autonomous manner, that is, without any type of cables, thus being versatile and adaptable to any display environment, without necessarily depending upon the power supply available on the surface of the shop where the stand for items will be exposed.

A further purpose of the invention is that of making an integrated system for displaying items and/or products and for promotional communication that is of the “modular” type, that is, that can be easily modified based upon the type of items on display and on the special offers.

These and other purposes according to the present invention are achieved by making an integrated system for displaying items and/or products and for promotional communication as outlined in claim 1.

Further characteristics of the invention are highlighted by the dependent claims, which are an integral part of the present description.

The characteristics and the advantages of an integrated system for displaying items and/or products and for promotional communication according to the present invention shall become clearer from the following description, given as an example and not for limiting purposes, with reference to the attached schematic drawings, in which:

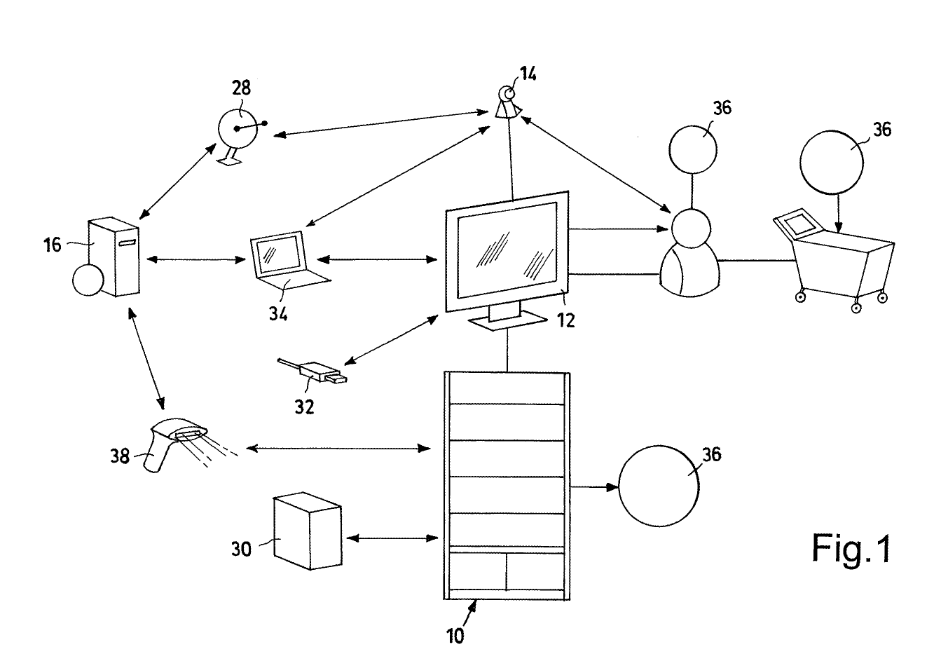

FIG. 1 is a schematic view of the fundamental components of the integrated system for displaying items and/or products and for promotional communication according to the present invention;

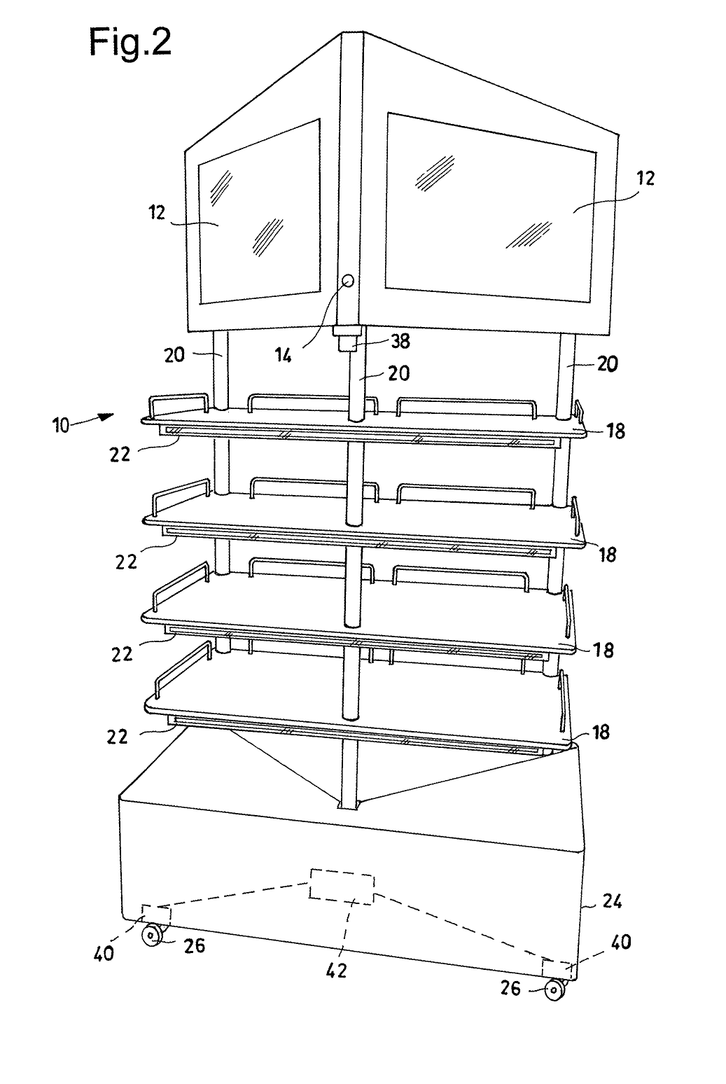

FIG. 2 shows a first embodiment of a single stand module of the integrated system for displaying items and/or products and for promotional communication according to the present invention;

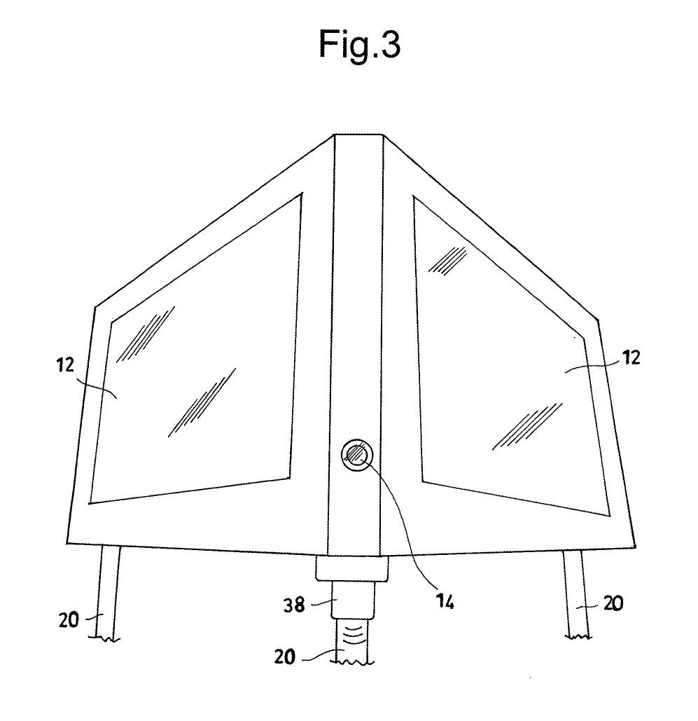

FIG. 3 is an enlarged view showing a detail of the stand module of FIG. 2;

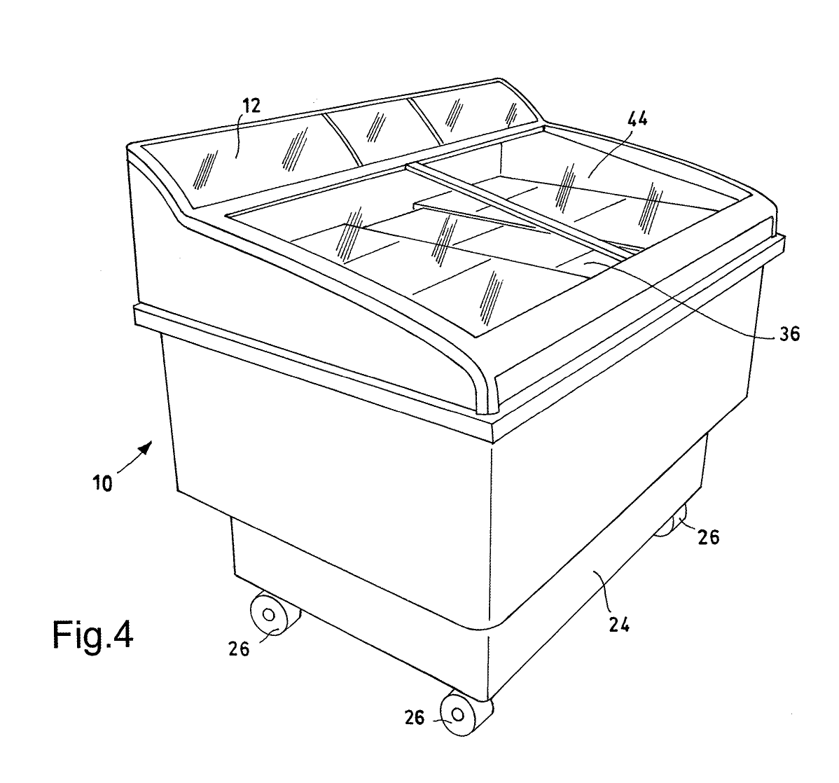

FIG. 4 shows a second embodiment of a single stand module of the integrated system for displaying items and/or products and for promotional communication according to the present invention;

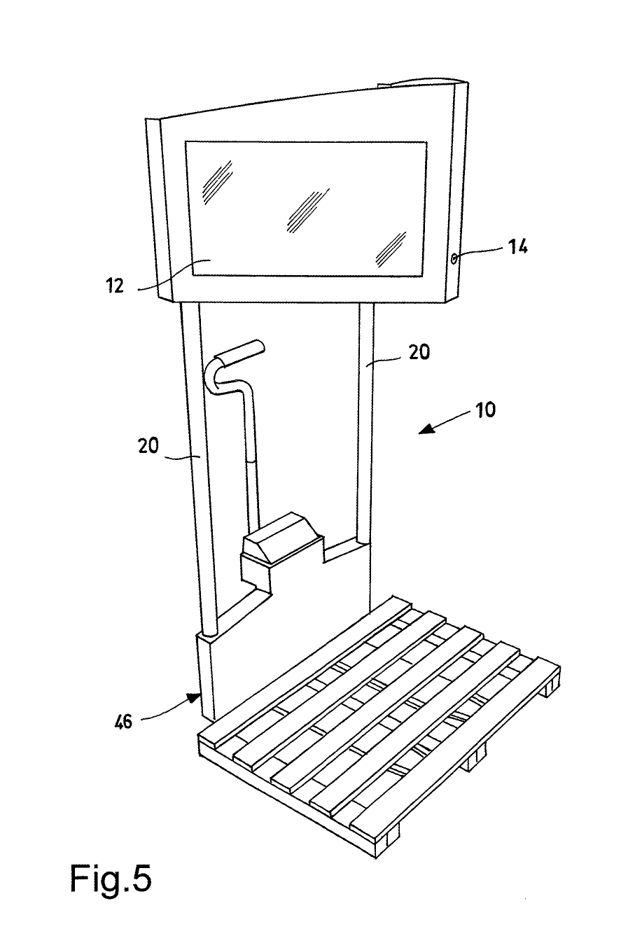

FIG. 5 shows a further example of application of the integrated system for displaying items and/or products and for promotional communication according to the present invention, intended in particular, as an additional function, to make the products themselves move; and

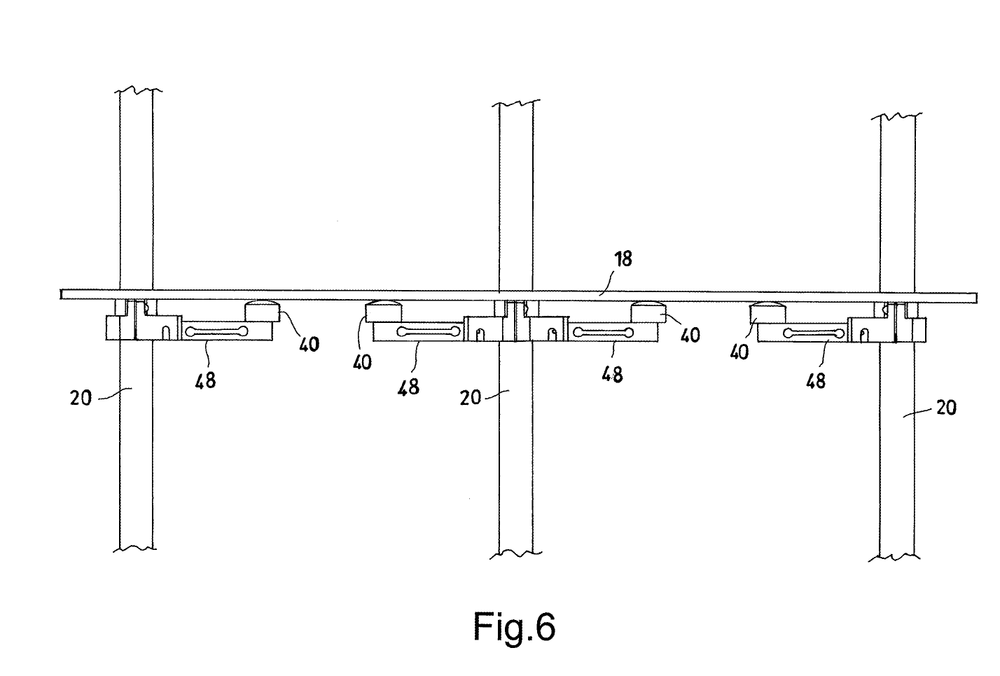

FIG. 6 is an enlarged view showing one embodiment of the devices for automatically identifying items which can be used in the integrated system for displaying items and/or products and for promotional communication according to the present invention.

With reference to the figures, an integrated system for displaying items and/or products and for promotional communication according to the present invention is shown. The system firstly comprises at least one stand module for displaying products, wholly indicated with reference numeral 10 and in turn comprising one or more support means designed to contain and/or to support the goods to be displayed, like for example a generic product 36 intended for sale.

The stand 10 comprises at least one screen 12 able to visualize a series of static or dynamic advertising messages with two-dimensional or with three-dimensional (3D) technology. According to the invention, the stand 10 also comprises at least one electronic device for acquiring dynamic images 14, like for example a digital video-camera with a CCD or CMOS technology, able to detect a series of information relating to people present within a predefined distance from the stand 10. In detail, this information concerns both the number of individuals who are stationary or in transit in front of the screen 12, which can therefore be identified as the people who are potentially interested in the advertising messages transmitted by the screen 12 itself, and the somatic characteristics of such individuals.

The video camera 14 is operatively connected, by means of a suitable wireless communication system 28 (Bluetooth®, Wi-Fi, UMTS/GPRS, etc.) or via cable, to a central processing unit 16 that is capable of receiving and elaborating, by means of a movement tracking and face or shape detection technology, the information coming from the video camera 14 itself. In particular, the central processing unit 16 is equipped with a special software for visual and automatic analysis which can determine in real time, from the information coming from the video camera 14, all that appears in front of such a video camera 14.

In detail, the central processing unit 16 is capable of analysing in real time not only the sex and the approximate age of the individuals that face towards the screen 12, but also the time of engagement/attention and the facial expression of such individuals consequent to the reaction to any message proposed by the dynamic communication on the screen 12, and/or the reaction consequent to the interaction with the products 36 displayed on the support means of the stand 10. Based upon the information received and elaborated, the central processing unit 16 is thus capable of identifying, in a precise and detailed manner, the number and the type of individuals (potential customers) who are stationary or in transit in front of the screen 12, and their reaction towards the products 36 and/or towards the advertising messages that are transmitted by such a screen 12.

In addition, since it is moreover operatively connected, by means of the wireless communication system 28 (Bluetooth®, Wi-Fi, UMTS/GPRS, etc.) or via cable, to the screen 12, the central processing unit 16 is moreover capable of activating or making the advertising message transmitted by the screen 12 vary in real time according to the information received by the video camera 14. In such a way the screen 12 can display, in real time, advertising messages that are much more tempting for the target people who are observing the screen 12 itself in that moment. Purely as an example, in the case in which the stand 10 contains different lines of cosmetic products, the screen 12 can be activated so as to propose advertisements relating to an aftershave if the video camera 14 detects the presence of male individuals, or it can be activated so as to propose advertisements relative to a perfume for women if the video camera 14 detects the presence of female individuals.

The central processing unit 16 can be provided with data storage devices, like for example mass storage devices like the well known hard disk, able to register the information received by the video camera 14. The information thus registered can be used for subsequent marketing researches, therefore representing data with considerable value for the companies that wish to purchase it or the advertising companies that wish to known how efficiently they are reaching their target. Such information can indeed converge into an analysis dashboard that re-elaborates it in an aggregated manner, so as to obtain output such as, for example, the measurement of the attention and of the time the customers are stood in front of the display in relation to the sell-out. Such data, for example, together with the correlation with the advertising message, gives way to further analysis such as the relevance of the factors that determine the sell-out.

It is important to underline that the central processing unit 16, by means of its own movement tracking and face or shape detection technology, does not identify each individual present in front of the screen 12, but classifies them simply based upon predefined demographical data, thus protecting the privacy of people. In other words, once the images have been received from the video camera 14, the central processing unit 16 does not register the images per se, but only a series of anonymous data (number of individuals, sex, age, etc.) obtained by elaborating the information coming from such images. In such a way the integrated system for displaying items and for promotional communication according to the present invention is less intrusive than a simple surveillance video camera, since it is not capable of interfering in any way with the privacy of the customers of the shop in which such a system is installed.

The central processing unit 16 and the video camera 14 can be provided with a system for analysing and recording the eye movements, or “eye-tracking” system. The eye-tracking system makes it possible to detect and track the eye movement of a certain individual on a visual surface, registering the dilation and the contraction of the pupils. Such a system makes it possible to precisely track the “user-experience” of the individual looking, registering the points and the areas that are visualised and the amount of time they have been visualised for. The eye-tracking system identifies the exact points on which the eyes are focused, it measures the actual time spent and indicates, for example, whether and how much the products 36 present on the support means of the stand 10 have been noticed and observed.

The eye-tracking system thus allows the central processing unit 16 to:

measure what each potential customer is looking at on the stand 10;

improve the impact of an advertising message transmitted by the screen 12;

understand the behaviour of each potential customer and the response to their visual stimuli.

Detailed information can thus be obtained concerning the visual paths of each potential customer and concerning the level of action that such a potential customer dedicates to the various products 36 that are present on the stand 10, as well as concerning the interaction between customer and product according to the position of the latter on the support means of the stand 10.

As shown in FIG. 2, the support means of the stand 10 can be made up of a plurality of shelves 18 with a substantially horizontal development, sustained by one or more vertical uprights 20. Each shelf 18 can advantageously be provided with lighting means 22, like for example light emitting diodes (LEDs), neon lights, incandescent lamps or yet more, to ensure a better view of the items present on the shelves 18 of the stand 10. If made in the form of light emitting diodes (LEDs), the lighting means 22 can generate a fading effect. Moreover, such shelves 18 can in turn house additional components, like for example hooks or stands (not shown), that are useful for a better display of the products 36 to be promoted.

The stand 10 can be provided with a box-shaped base 24, which can be opened to contain all the related constitutive elements, that is, the screen or the screens 12, the video camera 14, the vertical uprights 20 and the shelves 18 with the relative accessories, when the stand 10 itself is in a disassembled configuration, so as to facilitate transport and storing when not in use. Advantageously, to allow easy movement inside the shop, the stand 10 can also be provided inferiorly with a plurality of wheels 26. The stand structure 10, that is, the base 24, the vertical uprights 20 and the shelves 18, can be made from durable precious material, like for example metal and plexiglass, or from non durable materials, like for example paper, undulated cardboard or yet others.

Each stand module 10 can be provided with its own power generator 30, so as to electrically and independently, that is, without the need of a wire connection to the electric network, feed the screen or the screens 12, the video camera 14 and the possible lighting means 22. As an alternative or in addition to the power generator 30, each stand module 10 can also be provided with a normal cabled connection to the electric mains.

Advantageously the power generator 30 can be made up of one or more fuel cells, that is, an electrochemical generator supplied with a fuel (typically hydrogen) and with an oxidant (oxygen or air) so as to produce direct electrical current. Preferably, for reasons of maximum safety, each stand module 10 can be equipped with a methanol fuel cell, of the type known with the trade name “EFOY” and that is produced by the company “SFC Energy AG”, which suitably certifies the characteristics for use in indoor areas.

Each stand module 10 is advantageously provided with a device for automatically identifying items capable of detecting and identifying how many and which products 36 are present on the stand 10. The device for automatically identifying items is operatively connected, by means of the wireless communication system 28 or by means of another suitable communication system, to the central processing unit 16 so as to make it possible to measure, in a precise manner, how many and which products 36 are taken by the potential customers during the promotional display in shops. The central processing unit 16 is thus capable of combining the information coming from both the video camera 14, and from the device for automatically identifying items so as to detect both number and kind of people who have taken one or more products 36 from the stand 10.

The device for automatically identifying items can consist of a network of electronic sensors 40 that are capable of counting the products 36 present on the shelves 18. The counting data can be transmitted, by means of the wireless communication system 28 or by means of another suitable communication system, to the central processing unit 16 or to any portable electronic device for elaborating data 34 (personal computer, smart-phone, etc.) to be analysed in real time. For example, the electronic sensors 40 can be made up of weight sensors having the function of weighing the products 36 positioned on the shelves 18. The weight sensors 40 are connected to a control unit 42 (FIG. 2) which is housed inside the base 24 and that is operatively connected to the central processing unit 16.

The weight sensors 40 can be positioned between the base 24 and each wheel 26, as shown in FIG. 2. In one alternative embodiment, shown in FIG. 6, the weight sensors 40 can be, on the other hand, mounted on special supports 48 that are fixedly attached to the vertical uprights 20 and positioned below the single shelves 18. Preferably, the weight sensors 40 can be made up of fuel cells.

Alternatively, the device for automatically identifying items can be made up of an optical reading apparatus 38 that is able to detect and identify, on each product 36, a certain graphical symbol (image, logo, geometrical parameters that are useful for identifying an object or a piece of writing, etc.) suitable for recognising the type of product 36 taken from the stand 10. For example, the optical reading apparatus 38 can operate by means of a radio-frequency technology (RFID or “Radio Frequency Identification”) and can be substantially made up of a magnetic reader that is able to detect and identify the products 36 present on the stand module 10. For such a purpose, the products 36 should be equipped with a microchip which is “excited” when the magnetic reader 38 passes by, emitting a radio signal with medium frequency (signal HF) or of a few GHz (signal UHF). The radio frequency activates the microchip and provides it with the energy necessary in order to have a response to the magnetic reader 38, retransmitting a signal containing the information stored in the microchip itself to it.

The advertising messages can be loaded on the screen 12 by means of a portable mass storage device 32, like for example a USB device, a portable hard disk, a compact disc, a DVD or others, operatively connectable to the screen 12 itself. As an alternative, the advertising messages transmitted by the screen 12 can be generated through a video playback device (not shown), like for example a video recorder or a DVD reader, operatively connected to the screen 12 itself.

Finally, the advertising messages transmitted by the screen 12 can also be directly loaded onto the central processing unit 16, or onto any personal computer or smartphone 34 operatively connected to the screen 12 itself through the communication system 28, preferably of the wireless type. In any case it is foreseen, in addition or as an alternative to what has been shown above, that also the screen 12 can be provided with its own internal mass storage device able to contain the advertising messages to be transmitted.

As shown in FIG. 3, each stand module 10 can advantageously be provided with two distinct screens 12, facing the front wall of the stand module 10 itself but disposed according to a predefined angle (preferably at approximately 90°) to each other, so as to allow a better visibility of the advertising messages. Preferably the two screens 12 are arranged at an angle of approximately 90° to each other and each of such screens 12 is arranged at an angle of approximately 45° with respect to a plane passing through the front wall of the stand module. In such a way it is ensured for there to be a perfect visibility of the advertising messages by all potential customers in transit in proximity of the integrated system for displaying items and for promotional communication according to the present invention.

It can moreover be foreseen to use a plurality of stand modules 10 arranged side by side, which can be controlled by a single central processing unit 16 to transmit, on their respective screens 12, mutually identical or different advertising messages, according to the information coming from the respective video cameras 14 that each stand module 10 is provided with. A displaying structure can thus be created with large dimensions, capable of presenting different products and objects and of drawing the attention of a large number of potential customers.

FIG. 4 illustrates a particular embodiment of the stand module 10, intended in particular for the promotion and sale of fresh and frozen products. Such stand module 10 differs from that previously illustrated due to the fact that it is neither provided with shelves, nor base, which are replaced with a commercial refrigerated tank 44, with two different condensing groups that make it possible to operate at both negative and positive temperatures. All the other characteristics with relative functions remain unchanged.

FIG. 5 illustrates a further embodiment of the stand module 10 described, intended in particular to move the products. In such an embodiment the shelves and the base are replaced by a transpallet 46 provided at the top with at least one screen 12, at least one video camera 14 and all the other technical and functional characteristics of the stand modules 10 according to the embodiments previously described.

Of course, other embodiments of the stand module 10 may be foreseen based upon the specific requirements, including, purely as an example:

“worktop” version, almost identical in structure to the embodiments previously described, but with smaller dimensions so as to be rested on the worktop of a shop, or be used in other distribution channels which require smaller structures. Purely as an example, such a version could be used in pharmacies, in bars/tobacconist shops, in conventional retail shops and yet others;

“till-front” version, to be positioned at the tills of a shop and that differs from the embodiments described thus far due to the fact that it only has one screen 12 supported by an articulated supporting arm;

version with a fragrance diffuser that comprises, integrated in its own structure, one or more devices that are suitable for diffusing fragrances. The fragrance diffuser device can be independently fed or by means of the power generator 30 that is integrated in the stand module 10;

version with a screen 12 provided with sliding tracks, along which such a screen 12 can move horizontally with the purpose of coming closer to/moving away from other screens 12 of adjacent stand modules;

version with fidelity cards reader which comprises, integrated in its own structure, a device that is capable of reading the fidelity cards of customers and of attributing or dispensing such clients a benefit when a certain action has been carried out. The benefit could be for example the instant printing of a discount voucher which can be converted at the cashier points of the shop, or other ways to provide incentives correlated to the products on display;

version with “promoter/avatar video” comprising, integrated in its own structure, a device (which can be for example an additional iPAD® located at the front below the two screens 12) capable of providing, on demand of a customer (by pressing, for example, a call button), a real time communication or advice service which replaces the human role of the promoter, becoming for example also the avatar of the testimonial of the product communicated and displayed on the shelves 18. By connecting, the client will see and speak in real time with the promoter or with the avatar, which will provide, on demand, specific information related to the products displayed or other information based upon the options available. In such a case the form of communication is interactive and, therefore differs considerably from the dynamic communication that foresees messages that change but that cannot be selected by the user.

It has thus been seen that the integrated system for displaying items and/or products and for promotional communication according to the present invention achieves the purposes previously highlighted. The integrated system for displaying items and/or products and for promotional communication according to the present invention indeed integrates a structure and a series of technologies that are capable of identifying and storing which customer purchases/takes which product. Such an association of technologies makes it possible:

1. to identify the biometric characteristics of the potential customer (customer analysis);
2. to promote/communicate the product to be sold, by associating it with the customer profile (through the technique of “digital signage”);
3. to verify the taking of the product associated with the customer profile.

The companies who use the integrated system for displaying items and/or products and for promotional communication according to the present invention can present their products in a preferential display and according to a dynamic and innovative formula, but especially with the possibility of measuring, in a detailed manner, the traffic and the number of contacts with potential customers. The possibility of measuring the amount and the quality of the contact with the potential customers, in relation to the sales data, makes it possible to determine the return of investment in a precise and detailed manner.

The integrated system for displaying items and/or products and for promotional communication of the present invention thus conceived may, in any case, undergo numerous modifications and variants, all covered by the same inventive concept; moreover, all the details can be replaced by technically equivalent elements. In practice the materials used, as well as the shapes and sizes, can be any according to the technical requirements.

The scope of protection of the invention is thus defined by the attached claims.

1. Integrated system for displaying items and for promotional communication, comprising:
at least one stand module (10) for items, comprising in turn one or more support means (18) designed to contain and/or to support the products (36) to be displayed; and
at least one screen (12) and/or one panel able to visualize a series of static or dynamic advertising messages,
the system being characterised in that it comprises:
at least one electronic device (14) for acquiring dynamic images (14), able to detect a series of information relating to people present within a predefined distance from the stand module (10) for items;
at least one device for automatically identifying items (38; 40), able to detect and identify how many and which products (36) are present on the stand module (10); and
a central processing unit (16) operatively connected, by means of a suitable communication system (28), to said at least one electronic device (14) for acquiring dynamic images and to said at least one device for automatically identifying items (38; 40), said central processing unit (16) being capable:
a) of receiving and elaborating, by means of a movement tracking and face or shape detection technology, the information coming from the electronic device (14) for acquiring dynamic images, so as to detect both number and kind of people who are stationary or in transit in front of said at least one screen (12);
b) of receiving and elaborating the information coming from the device for automatically identifying items (38; 40), so as to precisely measure, instantaneously or in a defined time period, how many and which products (36) are taken from the stand module (10); and
c) of combining the information coming from the electronic device (14) for acquiring dynamic images and the information coming from the device for automatically identifying items (38; 40), so as to detect both number and kind of people who have taken one or more products (36) from the stand module (10).

2. System according to claim 1, characterised in that the central processing unit (16) is configured so as to identify the time of engagement/attention and the facial expression of the people consequent to the reaction to any advertising message transmitted by said at least one screen (12), and/or the reaction consequent to the interaction with the products (36) displayed on the support means (18).

3. System according to claim 1, characterised in that the central processing unit (16) is operatively connected, by means of the communication system (28), to said at least one screen (12) for activating, or for changing in real time, the advertising message transmitted by said screen (12) according to the information received by said at least one electronic device (14) for acquiring dynamic images.

4. System according to claim 1, characterised in that the central processing unit (16) is provided with data storage devices able to register the information received by the electronic device for acquiring dynamic images (14), the information so registered being available for subsequent marketing researches.

5. System according to claim 1, characterised in that the central processing unit (16) and the electronic device (14) for acquiring dynamic images are provided with a system for analysing and recording eye movements, or “eye-tracking” system, which makes it possible to detect and track the movement of the eyes of a certain individual so as to evaluate whether and how much the products (36) present on the support means (18) have been noticed and observed.

6. System according to claim 1, characterised in that the support means (18) are formed by a plurality of shelves with a substantially horizontal development, sustained by one or more vertical uprights (20), each shelf (18) being provided with lighting means (22) to ensure a better visibility of the items present on the stand module (10) for items.

7. System according to claim 6, characterised in that each stand module (10) for items is provided with a box-shaped base (24), which can be opened to contain all the related constitutive elements, that is, said at least one screen (12), the electronic device (14) for acquiring dynamic images, the vertical uprights (20) and the shelves (18) with the relative accessories, when said stand module (10) for items is in a disassembled configuration, so as to facilitate transport and storing when not in use.

8. System according to claim 6, characterised in that each stand module (10) for items is provided inferiorly with a plurality of wheels (26) to allow easy handling.

9. System according to claim 1, characterised in that each stand module (10) for items is provided with its own power generator (30), so as to electrically and independently feed, that is, without the need of a wire connection to the electric network, said at least one screen (12) and said at least one electronic device (14) for acquiring dynamic images.

10. System according to claim 9, characterised in that the power generator (30) is formed by one or more fuel cells.

11. System according to claim 1, characterised in that the device for the automatic identification of items is made up of a network of electronic sensors (40) able to count the products (36) positioned on the support means (18), the counting data being able to be transmitted, by means of the communication system (28), to the central processing unit (16) or to any portable electronic device (34) for the elaboration of data to be analysed in real time.

12. System according to claim 11, characterised in that the electronic sensors (40) are made up of weight sensors having the function of weighing the products (36) positioned on the support means (18), said weight sensors being connected to a control unit (42) operatively connected to the central processing unit (16).

13. System according to claim 1, characterised in that the device for automatically identifying items is made up of at least one optical reading apparatus (38) that is able to detect and identify, on each product (36), a certain graphical symbol suitable for identifying the type of product (36) taken from the stand module (10).

14. System according to claim 13, characterised in that the optical reading apparatus (38) is made up of a magnetic reader operating by means of radio-frequency technology (RFID).

15. System according to claim 1, characterised in that the advertising messages can be loaded onto said at least one screen (12) by means of a portable mass storage device (32) operatively connectable to said at least one screen (12).

16. System according to claim 1, characterised in that the advertising messages transmitted by said at least one screen (12) can be generated by means of a video playback device operatively connected to said at least one screen (12).

17. System according to claim 1, characterised in that the advertising messages transmitted by said at least one screen (12) can be directly loaded on the central processing unit (16), or on any portable electronic device for processing data (34) operatively connected to said at least one screen (12) through the communication system (28).

18. System according to claim 1, characterised in that said at least one screen (12) is provided with its own internal mass storage device able to contain the advertising messages to be transmitted.

19. System according to claim 1, characterised in that the electronic device for acquiring dynamic images (14) is a digital video-camera with a CCD or CMOS technology.

20. System according to claim 1, characterised in that the communication system (28) is of the wireless type.

21. System according to claim 1, characterised in that each stand module (10) for items is provided with two distinct screens (12), facing the front wall of said stand module (10) for items, but disposed at an angle of approximately 90° to each other, each of said screens (12) being also disposed at an angle of approximately 45° with respect to a plane passing through the front wall of the stand module, so as to allow a better visibility of the advertising messages.

22. System according to claim 1, characterised in that it comprises a plurality of stand modules (10) for items arranged side by side, which can be controlled by a single central processing unit (16) to transmit, on their respective screens (12), mutually identical or different advertising messages, according to the information coming from the respective electronic devices (14) for acquiring dynamic images of which each stand module (10) for items is provided with.
